(19) United States
(12) Patent Application Publication
(10) Pub. No.: US 2023/0285865 A1
(43) Pub. Date: Sep. 14, 2023

(54) METHOD FOR PROCESSING RECOMMENDATION INFORMATION, ELECTRONIC DEVICE AND NON-VOLATILE COMPUTER-READABLE STORAGE MEDIUM

(71) Applicant: NETEASE (HANGZHOU) NETWORK CO., LTD., Hangzhou, Zhejiang (CN)

(72) Inventor: Zequan ZHANG, Hangzhou, Zhejiang (CN)

(73) Assignee: NETEASE (HANGZHOU) NETWORK CO., LTD., Hangzhou, Zhejiang (CN)

(21) Appl. No.: 18/001,720

(22) PCT Filed: Nov. 18, 2020
(86) PCT No.: PCT/CN2020/129853

§ 371 Date: Dec. 14, 2022

(30) Foreign Application Priority Data
Jul. 22, 2020 (CN) 202010711321.8

(51) Int. Cl. A63F 13/87; A63F 13/533; A63F 13/79

(52) U.S. Cl. CPC A63F 13/87; A63F 13/533; A63F 13/79

(57) ABSTRACT

A method for processing recommendation information, an electronic device and a non-volatile computer-readable storage medium storage medium are provided. The method includes: displaying a recommendation and appreciation interface for at least one second game player on a graphical user interface, wherein a game interaction between the at least one second game player and a first game player corresponding to a first terminal device meets a preset interaction condition; in response to an appreciation operation on the second game player in the recommendation and appreciation interface, sending first appreciation information to a second terminal device corresponding to the second game player.

### CROSS-REFERENCE

The present application is a U.S. National Stage of International Application No. PCT/CN2020/129853, filed on Nov. 18, 2020, and claims the priority to the Chinese Patent Application NO. 202010711321.8, entitled “METHOD AND APPARATUS FOR PROCESSING RECOMMENDED INFORMATION, AND DEVICE AND STORAGE MEDIUM”, filed on Jul. 22, 2020, the entire contents of which are hereby incorporated by reference.

### TECHNICAL FIELD

Embodiments of the present disclosure relates to a field of games, and more particularly to a method and an apparatus for processing recommendation information, a device and a storage medium.

### BACKGROUND

Current multiplayer competitive games provide an appreciation function, that is, a player may appreciate players who have made positive contributions to a game or performed well (including showing competitive style, team spirit and excellent command), and may also gain additional game experience for the player while appreciating others.

### SUMMARY

A first aspect of embodiments of the present disclosure provides a method for processing recommendation information, the method includes:
generating, by a first terminal device, a graphical user interface by executing and rendering a game application on a display of the first terminal device;
displaying a recommendation and appreciation interface for at least one second game player on the graphical user interface, wherein a game interaction between the at least one second game player and a first game player corresponding to the first terminal device meets a preset interaction condition;
in response to an appreciation operation on the second game player in the recommendation and appreciation interface, sending first appreciation information to a second terminal device corresponding to the second game player.

A second aspect of embodiments of the present disclosure provides an electronic device, including: a memory, a processor and a display;
wherein the memory is configured to store a computer program and data;
the processor is configured to call the computer program stored in the memory to cause the processor to execute a method for processing the recommendation information; and the method includes:
generating, by a first terminal device, a graphical user interface by executing and rendering a game application on a display of the first terminal device;
displaying a recommendation and appreciation interface for at least one second game player on the graphical user interface, wherein a game interaction between the at least one second game player and a first game player corresponding to the first terminal device meets a preset interaction condition;
in response to an appreciation operation on the second game player in the recommendation and appreciation interface, sending first appreciation information to a second terminal device corresponding to the second game player;
the display is configured to render the data to the graphical user interface.

A third aspect of embodiments of the present disclosure provides a non-volatile computer-readable storage medium having a computer program stored thereon, which, when executed by a processor, causes the processor to execute the following operations:
generating, by a first terminal device, a graphical user interface by executing and rendering a game application on a display of the first terminal device;
displaying a recommendation and appreciation interface for at least one second game player on the graphical user interface, wherein a game interaction between the at least one second game player and a first game player corresponding to the first terminal device meets a preset interaction condition;
in response to an appreciation operation on the second game player in the recommendation and appreciation interface, sending first appreciation information to a second terminal device corresponding to the second game player.

### BRIEF DESCRIPTION OF THE DRAWINGS

FIG. 1 is a schematic diagram of a scene of a method for processing recommendation information provided by an embodiment of the present disclosure;

FIG. 2 is a flow diagram of a method for processing recommendation information provided by an embodiment of the present disclosure;

FIG. 3 is a schematic diagram of a recommendation and appreciation interface provided by an embodiment of the present disclosure;

FIG. 4 is a schematic diagram of a recommendation and appreciation interface provided by an embodiment of the present disclosure;

FIG. 5 is a schematic diagram of a recommendation and appreciation interface provided by an embodiment of the present disclosure;

FIG. 6 is a schematic diagram of a recommendation and appreciation interface provided by an embodiment of the present disclosure;

FIG. 7 is a schematic diagram of a recommendation and appreciation interface provided by an embodiment of the present disclosure;

FIG. 8 is a flow diagram of a method for processing recommendation information provided by an embodiment of the present disclosure;

FIG. 9 is a schematic diagram of a global appreciation interface provided by an embodiment of the present disclosure;

FIG. 10 is a schematic diagram of a global appreciation interface provided by an embodiment of the present disclosure;

FIG. 11 is a schematic diagram of changes in summary information of a player in a global appreciation interface provided by an embodiment of the present disclosure;

FIG. 12 is a flow diagram of a method for processing recommendation information provided by an embodiment of the present disclosure;

FIG. 13 is a flow diagram of a method for processing recommendation information provided by an embodiment of the present disclosure;

FIG. 14 is a schematic diagram of a recommendation and appreciation interface provided by an embodiment of the present disclosure;

FIG. 15 is a structural diagram of an apparatus for processing recommendation information provided by an embodiment of the present disclosure;

FIG. 16 is a schematic diagram of a hardware structure of an electronic device provided by an embodiment of the present disclosure.

### DETAILED DESCRIPTION

In order to make the objectives, technical solutions, and advantages of embodiments of the present disclosure more clearly, the technical solutions in the embodiments of the present disclosure will be clearly and completely described in the following with reference to the accompanying drawings in the embodiments of the present disclosure. It is obvious that the described embodiments are only a part of the embodiments, but not all embodiments, of the present disclosure. All other embodiments obtained by those skilled in the art based on the embodiments of the present disclosure without inventive efforts are within the scope of the present disclosure.

The terms “first”, “second”, “third”, “fourth”, etc. (if present) in the description and claims of the present disclosure and the above drawings are used to distinguish similar objects without being necessarily used to describe a specific order or an order of priority. It should be understood that the data so used may be interchanged where appropriate, so that the embodiments of the present disclosure described herein can be implemented in an order other than those illustrated or described herein.

It should be understood that in the present disclosure, “comprising” and “including” and any variants thereof are intended to cover a non-exclusive inclusion, for example, a process, method, system, product, or device that includes a series of steps or units is not necessarily limited to those steps or units that are clearly listed, but may include other steps or units that are not clearly listed or inherent to such process, method, product or device.

At present, the game server provides an appreciation function. After the game ends, a player may spontaneously appreciate other players. The original design intention of the appreciation function is for appreciating players with excellent behaviors, such as those who lead a team to victory, put team interests first, win with grace, and lose with attitude. The appreciation may be viewed in a player's career profile, a team formation interface and more places, so that other players may know a specific situation of the player. A player who keeps a high appreciation value may be rewarded periodically, while a player who has behaved negatively or has been banned for many times will lose all the appreciation value. Accumulating the appreciation value will help to gain trust of more teammates in the game. The higher the appreciation value, the more advantageous it will be in finding a team.

Appreciating others is usually a kind of “selfless dedication”, and it is unlikely to be appreciated by other players. In the related art, after end of each game, the game interface displays all the data of teammates in a game battle and provides a corresponding like function. The player may use the like function to select a preset appreciation label to send appreciation information to the teammate players.

However, in most cases, the player appreciates other players based on his/her feelings, such as only appreciating players who have good skills or know each other. In this way, the appreciation information sent by the player cannot objectively reflect the performance of the teammate players in the game, and liking only a few players also causes uneven distribution of the game appreciation and a low mutual appreciation rate between the players, thereby affecting game experience of the players.

In most cases, the player appreciates other players based on his/her feelings after the game ends, and rarely for exact reasons. Most of the time, he/she only appreciate players who have good skills or know each other, so that the appreciation information sent by the player cannot objectively reflect the performance of teammate players in the game, therefore do not achieve the above-mentioned original design intention. During the actual game, the appreciation received by the players is also limited, which may be caused by uneven distribution of the appreciation or too complex appreciation operation.

In order to improve the appreciation rate between the players and the objectivity of the appreciation information, and to achieve a benign evaluation, the embodiments of the present disclosure provide a method for processing the recommendation information, which aims to recommend other players available for appreciation for the player. The recommended other players have a strong correlation with the player, for example, the number of interactions between the players is relatively high, and the number of interactions may reflect the mutual assistance and consistency between the players during the game. The player views the recommendation information sent by a server on a graphical user interface of a terminal device, and selects the players they want to appreciate from the recommended other players. Since the recommendation information is obtained by the server according to statistics of the game history data, the recommendation information reflects the real interactive data of the game, and the players have a strong sense of identity, which may improve the appreciation rate between the players.

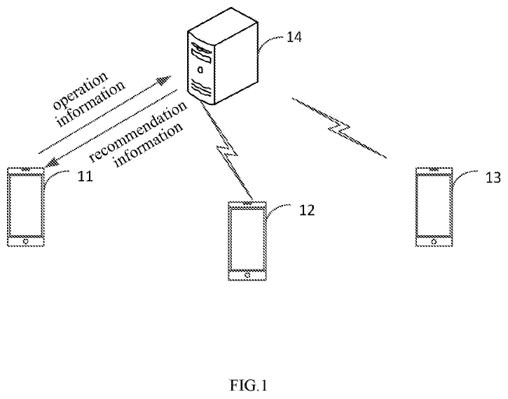

FIG. 1 is a schematic diagram of a scene of a method for processing recommendation information provided by an embodiment of the present disclosure. As shown in FIG. 1, the scene includes a plurality of terminal devices (such as terminal devices 11, 12, 13 in FIG. 1) and a game server 14, and the plurality of terminal devices are communicated with the game server 14, respectively.

Each terminal device sends the operation information of different players in a same game scene to the game server. After the game ends, the game server determines the information of other players recommended to each player according to the historical operation information of each player, and sends the recommendation information to the terminal device of each player, and the terminal device displays the recommendation information on the graphical user interface according to the recommendation information.

Taking the terminal device 11 as an example, as shown in FIG. 1, the player 1 is connected to the game server 14 through the terminal device 11. The terminal device 11 sends the operation information of the player 1 in the game to the game server 14, which records the historical operation information of each player in the game and the interactive information of the cooperation operation between the each player and other players in the game battle. When the game ends, the game server 14 may send the recommendation information to the terminal device 11 of the player 1 according to the historical operation information of the player 1 in the game and interactive information of the interaction with other players, which is used to recommend to the player 1 at least one of the other players who has interacted with the player 1 more than a preset number threshold in the game. The terminal device 11 displays the recommendation information on the graphical user interface. It should be understood that different players have different recommendation information. Each player may appreciate the other players according to the recommendation information displayed on the graphical user interface to achieve interactive appreciation between the players.

It should be noted that the above scene is merely a kind of example, and the above execution actions of the game server may also be performed by the terminal device, which is not limited in the embodiments of the present disclosure.

Technical solutions provided by the present disclosure will be described in detail below with several specific embodiments. It should be noted that the following specific embodiments may be combined with each other. For same or similar content, descriptions are not repeated in different embodiments.

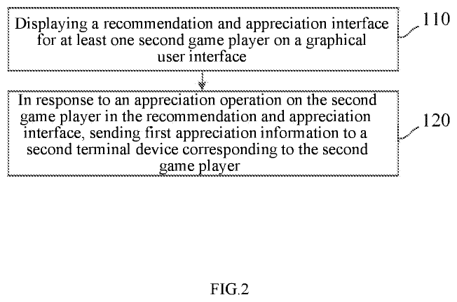

FIG. 2 is a flow diagram of a method for processing recommendation information provided by an embodiment of the present disclosure. As shown in FIG. 2, the processing method provided by the present embodiment includes the following steps 110 to 120.

In the step 110, a recommendation and appreciation interface for at least one second game player is displayed on a graphical user interface, a game interaction between the at least one second game player and a first game player corresponding to the first terminal device meets a preset interaction condition.

The method for processing recommendation information provided by the present embodiment may be applied to a multiplayer competitive game, including multiplayer collaboration. The multiplayer collaboration means that the players are divided into two or more teams, and players in the same team cooperate with each other to complete team tasks until end of the game. A first game player is any one of a plurality of players in the same game scene. The player collaborates with the players in the same team to destroy enemies. When necessary, the player may help the teammate player to fend off damage, or give the teammate player a life value for treatment. Similarly, the player may also accept the help or the life value given by the teammate player.

In the present embodiment, after the game ends, the graphical user interface of the first terminal device corresponding to a first game player displays a recommendation and appreciation interface for a second game player. Specifically, by acquiring a historical record of the first game player in this game, and according to the historical record of the first game player in this game, at least one second game player whose game interaction with the first game player in this game meets the preset interaction condition may be determined.

The historical record of the first game player in this game includes a historical operation record of the first game player and an interaction record of the interaction with other players in this game. The historical operation record includes a shooting operation and a skill release operation of the first game player in the game scene. The interaction record of the interaction with other players includes a record of the first game player giving or receiving the life value of other players, a record of the first game player collaborating with other players, a record of the first game player and other players jointly destroying the enemy, a record of other players fending off damage for the first game player, a record of the first game player fending off damage for other players, a chat record between the first game player and other players, and a record of the first game player exchanging emojis with other players and the like.

In the embodiment of the present disclosure, the preset interaction condition includes at least one of the following conditions:
a number of game interactions being greater than a preset number threshold, and a game interaction duration being greater than a preset time threshold.

As an example, the second game player is a player whose number of game interaction with the first game player is greater than the preset number threshold. As an example, the second game player is a player whose game interaction duration with the first game player is greater than the preset time threshold. As an example, the second game player is a player whose number of game interaction with the first game player is greater than the preset number threshold, and whose game interaction duration with the first game player is greater than the preset time threshold.

In some embodiments, in some embodiments, the above preset interaction condition includes a preset interaction condition related to a game interaction type. Different game interaction types have different preset interaction conditions.

As an example, the game interaction type includes at least one of the following: an assist type, a rescue type, a collaboration type, and a guard type. The preset interaction condition of the assist type includes: a quantity of enemies destroyed together with the first game player being greater than a first quantity, or a number of assists for the first game player being greater than a first number. The preset interaction condition of the rescue type includes: a total amount of a life value given to the first game player being greater than a second quantity, or a number of rescues for the first game player being greater than a second number. The preset interaction condition of the collaboration type includes: a number of collaborations with the first game player being greater than a third number. The preset interaction condition of the guard type includes: a total amount of damage off which the first game player is helped to fend being greater than a third quantity, or a number of times that the first game player is helped to fend off damage being greater than a fourth number.

In some embodiments, the first appreciation information matches the game interaction type. For example, when the quantity of enemies destroyed jointly by the first and second game players in the game exceeds the preset quantity, the first appreciation information sent may be “pleasant cooperation”. In this way, the first game player may be adaptively provided with appropriate first appreciation information according to the game interaction type, so that the content of the first appreciation information sent may more accurately reflect the contribution of the teammate in the game, and improve the recognition and enthusiasm for the game appreciation between the players.

In the embodiment of the present disclosure, the recommendation and appreciation interface includes an appreciation control corresponding to each second game player. In some embodiments, the recommendation and appreciation interface also includes at least one of a name, an avatar, an interaction record and an appreciation label of the second game player.

The interaction record refers to an interaction record between the first game player and the second game player, such as the number of enemies jointly destroyed by the first game player and the second game player, the total amount of the life value given by the second game player to the first game player, the number of collaborations between the second game player and the first game player, and the number of times that the second game player helps the first game player to fend off damage, and the like.

The appreciation label is used to indicate appreciation evaluation information for the second game player, and the appreciation label includes a preset appreciation label or a user-defined appreciation label. The user-defined appreciation label may meet the personalized needs of different players. In some embodiments, the appreciation label includes “gratitude”, “esports spirit”, “pleasant cooperation”, “guru”, “turn tides”, “getting along well”, and the like.

In the step 120, in response to an appreciation operation on the second game player in the recommendation and appreciation interface, sending first appreciation information to a second terminal device corresponding to the second game player.

The first appreciation information is appreciation evaluation information determined according to the game interaction. The first appreciation information sent to the second game player may include the above appreciation label, such as “gratitude”, “esports spirit”, “pleasant cooperation”, “guru”, “turn tides”, “getting along well”, and the like.

As an example, in response to the appreciation operation of first game player on the second game player in the recommendation and appreciation interface, that is, the like operation, according to the game interaction between the first game player and the second game player in this game (that is, the interaction record), a corresponding first appreciation information is sent to the second terminal device corresponding to the appreciated second game player. The first appreciation information is the appreciation evaluation information corresponding to the game interaction. For example, according to a record of the life value given by the second game player to the first game player, the second terminal device is sent with “gratitude” and other appreciation evaluation information.

As another example, in response to the appreciation operation acting on the appreciation control, the appreciation control displays an appreciation label (the label may be a preset label determined according to the game interaction record between the players), and the first appreciation information including the appreciation label is sent to the second terminal corresponding to the second game player.

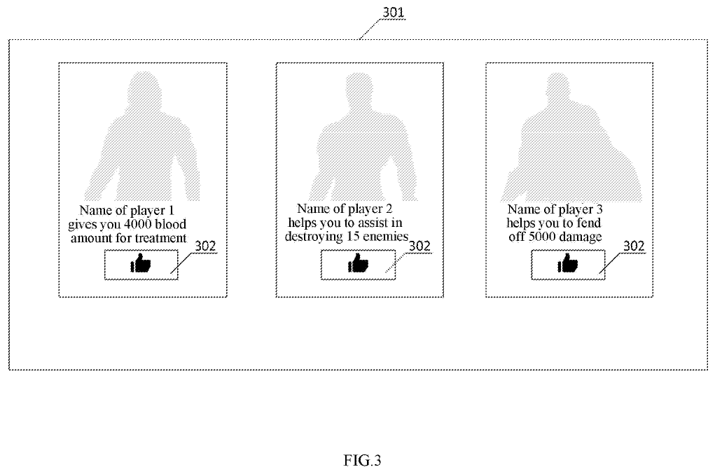

FIG. 3 is a schematic diagram of a recommendation and appreciation interface provided by an embodiment of the present disclosure. As shown in FIG. 3, the recommendation and appreciation interface 301 recommends three second game players to the first game player, namely player 1, player 2, and player 3. The name of the players, the interaction record with the first game player, and the appreciation control 302 are displayed below each player's avatar. The first game player may acquire the interaction record between each recommended player and the first game player according to the recommendation and appreciation interface 301. For example, the player 1 gave the first game player 4000 blood amount for treatment, player 2 helped the first game player to assist in destroying 15 enemies, and player 3 helped the first game player to fend off 5000 damage. The first game player selects the player to be appreciated according to the above interaction record, and may select the player to be appreciated by clicking the appreciation control 302, and may select one or more players.

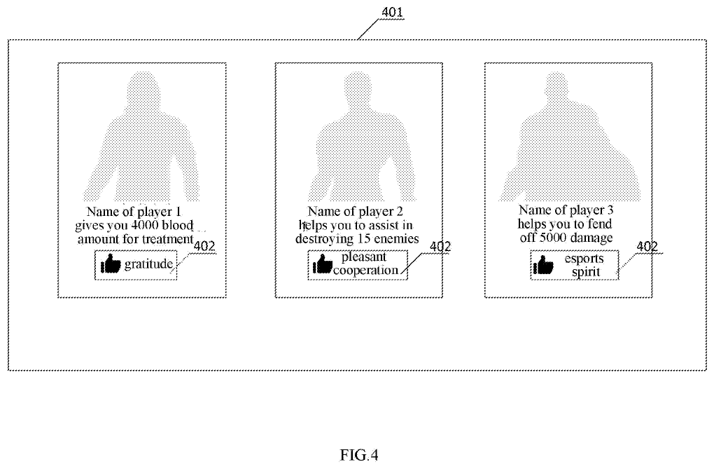

In some embodiments, the appreciation label is displayed on the appreciation control, and is a preset appreciation label, usually in one-to-one correspondence to the interaction record. FIG. 4 is a schematic diagram of a recommendation and appreciation interface provided by an embodiment of the present disclosure. On the basis of the recommendation and appreciation interface shown in FIG. 3, as shown in FIG. 4, the recommendation and appreciation interface 401 displays the avatar and name of the recommended second game player, the interaction record with the first game player, and the appreciation control 402. The appreciation control 402 displays the appreciation label, for example, an appreciation label corresponding to the player 1 is “gratitude”, an appreciation label corresponding to the player 2 is “pleasant cooperation”, an appreciation label corresponding to the player 3 is “esports spirit”.

Different interaction records may correspond to different appreciation labels, and the corresponding relationship between the two may be preset by the game server. For example, the interaction record is a record of life value given to the first game player, and a corresponding appreciation label is “gratitude”, the interaction record is a record of destroying enemies together with the first game player, and a corresponding appreciation label is “happy cooperation”, the interaction record is a record of fending off damage for the first game player, and a corresponding appreciation label is “esports spirit”.

In some embodiments, as an example, no appreciation label is displayed on the appreciation control, and the recommendation and appreciation interface provides at least one preset appreciation evaluation information. Specifically, the first game player may call the preset appreciation evaluation information by clicking or long pressing the appreciation control on the recommendation and appreciation interface. As an example, in response to the click or long press operation of the first game player on the appreciation control, an appreciation label selection window is displayed above the appreciation control, and the appreciation label selection window includes a plurality of appreciation labels or user-defined appreciation labels that may be selected by the first game player.

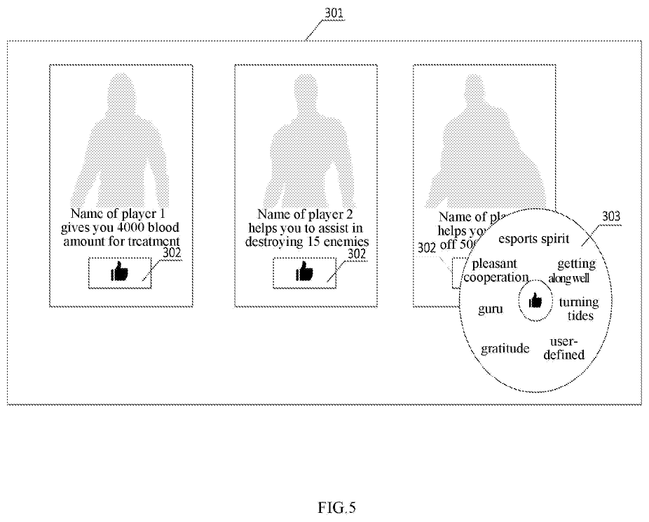

FIG. 5 is a schematic diagram of a recommendation and appreciation interface provided by an embodiment of the present disclosure. As shown in FIG. 5, in response to an operation of the first game player clicking on the appreciation control, an appreciation label window 303 is displayed on an upper layer of the recommendation and appreciation interface 301. The appreciation label window 303 includes a plurality of appreciation labels that may be selected by the first game player, such as “gratitude”, “present cooperation”, “esports spirit”, “turn tides”, “guru” “getting along well”, or a user-defined appreciation label. For the appreciation label, the system preset may be performed according to the specific game content, which is not limited in the present embodiment.

In the above example, the first game player may select the appropriate appreciation label or the user-defined the appreciation label for the second game player through the appreciation label window to achieve the player's independent selection of the appreciation label and improve the flexibility of the player's appreciation operation.

It should be noted that the embodiments of the present disclosure do not limit a display form of the above appreciation label window, which may be a circle as shown in FIG. 5, or other forms, such as a rectangular list, a drop-down box, and the like.

In some embodiments, the recommendation and appreciation interface may also include a first control, and the first control is used to directly skip an appreciation operation on the second game player or submit an appreciation.

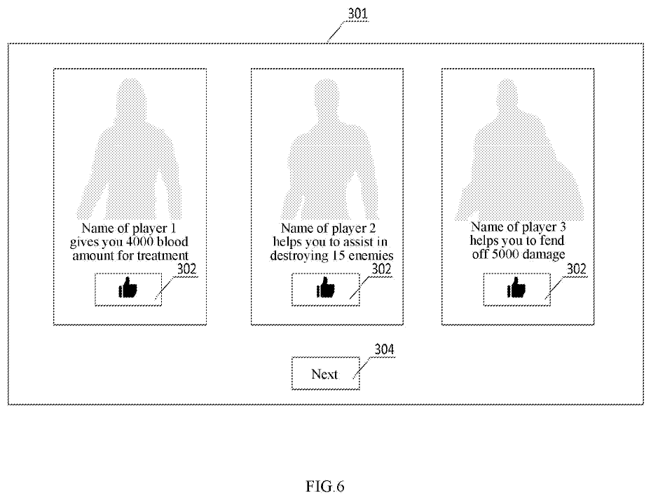

FIG. 6 is a schematic diagram of a recommendation and appreciation interface provided by an embodiment of the present disclosure. As shown in FIG. 6, the recommendation and appreciation interface 301 also includes a first control 304. As an example, after the first game player selects one or more players to appreciate, he/she may click the first control 304 to submit the appreciation. As another example, if the first game player does not want to appreciate the recommended player on the recommendation and appreciation interface 301, he/she may directly jump to a next graphical user interface by clicking the first control 304.

In some embodiments, the recommendation and appreciation interface may also include a second control, and the second control is used to display countdown information.

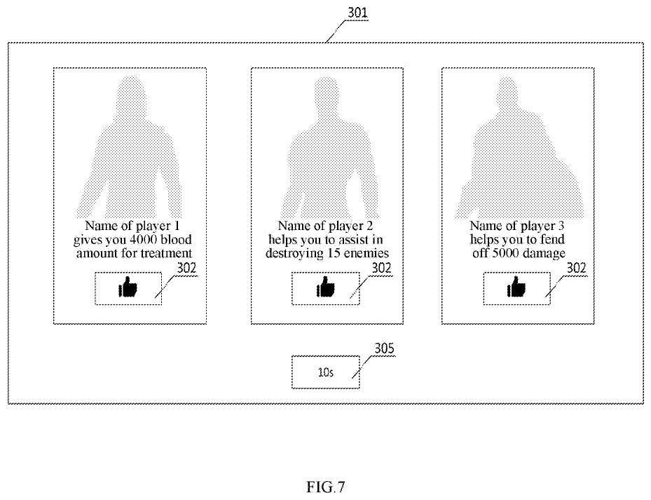

FIG. 7 is a schematic diagram of a recommendation and appreciation interface provided by an embodiment of the present disclosure. As shown in FIG. 7, the recommendation and appreciation interface 301 also includes a second control 305, which is used to display the countdown information. After the countdown ends, it jumps to the next graphical user interface. As an example, according to a preset time, such as 10s, the first game player may appreciate one or more second game players within the preset time. If the preset time is exceeded, the interface will automatically switch to the next graphical user interface.

It should be noted that if the first game player has selected one or more players on the recommendation and appreciation interface 301 before the countdown ends, the appreciation for these players may be submitted when the interface switches, and the appreciation information is sent to the terminal devices corresponding to these players.

According to the method for processing the recommendation information provided by the embodiments of the present disclosure, after the game ends, a recommendation and appreciation interface for at least one second game player is displayed on the graphical user interface of the first terminal device of the first game player, and the game interaction between the at least one second game player and the first game player meets the preset interaction condition, and in response to the appreciation operation on the second game player in the recommendation and appreciation interface, the first appreciation information is sent to the second terminal device corresponding to the second game player. Since the above method directly recommends to the first game player at least one second game player who is available for appreciation and has high interaction with the player, and displays it on the interface to facilitate the first game player's selection, while the second game player may know whether he/she is appreciated, which may improve the appreciation rate between the players, enhance the interaction of the game, and improve the game experience of the players.

The above examples show a method for processing recommendation information. After the game ends, other players with high interaction with the player are recommended to the player. At least one of the name, the avatar, the interaction record and the appreciation label of the other player may be displayed on the graphical user interface to facilitate the players' appreciation. However, since the game server only recommends the player who has the highest interaction record with the player, the player having the second highest or third highest interaction record cannot be recommended, and the player cannot appreciate the player having the second highest or third highest interaction record on the above graphical user interface.

To solve the above problem, embodiments of the present disclosure also provide a method for processing recommendation information. On the basis of the above embodiments, a global appreciation interface including all players is provided for the player, so that the player may supplement appreciation for other players who have not been recommended on the interface.

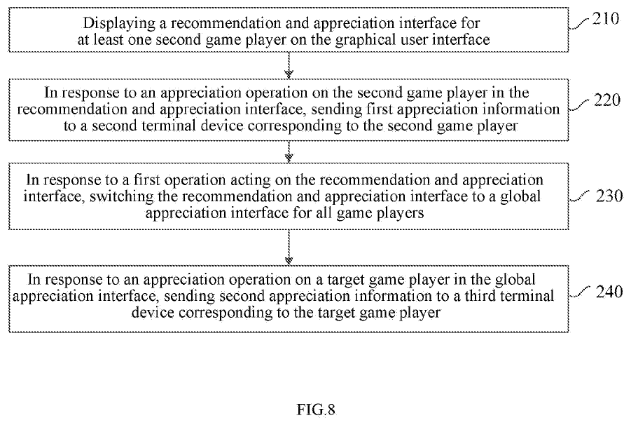

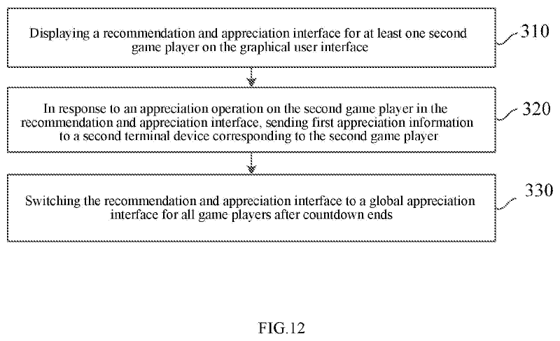

The method for processing recommendation information is described in detail below in combination with FIG. 8 and FIG. 12.

FIG. 8 is a flow diagram of a method for processing recommendation information provided by an embodiment of the present disclosure. As shown in FIG. 8, the processing method provided by the present embodiment includes the following steps 210 to 230.

In the step 210: a recommendation and appreciation interface for at least one second game player is displayed on the graphical user interface, a game interaction between the at least one second game player and a first game player corresponding to the first terminal device meets a preset interaction condition.

In the step 220: in response to an appreciation operation on the second game player in the recommendation and appreciation interface, first appreciation information is sent to a second terminal device corresponding to the second game player.

The step 210 and step 220 of the present embodiments are the same as the step 110 to the step 120 of the above embodiments. For details, reference may be made to the foregoing embodiments, which is not repeated here.

In the step 230: in response to a first operation acting on the recommendation and appreciation interface, switching the recommendation and appreciation interface to a global appreciation interface for all game players.

The global appreciation interface displays the summary information of each player in the game. All game players may be all teammate players included in the game battle, including the second game player (i.e. the recommended other players) of the above embodiments.

In some embodiments, the global appreciation interface includes an appreciation control corresponding to each player.

As an example, the first operation may be a click operation. Specifically, in response to a click operation acting on the first control in the recommendation and appreciation interface, the following two cases are provided:
in a first case, the first game player appreciates at least one second game player by clicking an appreciation control corresponding to the at least one second game player on the recommendation and appreciation interface, and then submits the appreciation by clicking the first control. In a second case, the first game player directly clicks the first control on the recommendation and appreciation interface to skip appreciating the recommended player.

In response to the click operation on the first control, the recommendation and appreciation interface of the first game player is controlled to switch to the global appreciation interface, and the first game player may also select the player who needs to be appreciated on the global appreciation interface.

The global appreciation interface of the present embodiment may display the summary information of each player in this game, including the summary information of the first game player himself/herself. In some embodiments, the global appreciation interface may also display the summary information of other players besides the first game player.

If the global appreciation interface may display the summary information of all players in the game, in some embodiments, the appreciation control may be arranged at the end of the summary information of the first game player, that is, to provide the function that the player appreciates himself/herself. Of course, the appreciation control may not be arranged at the end of the summary information of the first game player, and that is the first game player cannot appreciate himself/herself, but only appreciate other players, which is not limited in the present embodiment.

In the present embodiment, the summary information of each player includes at least one of an avatar, a name, and a game record of the player. In some embodiments, the game record includes a total quantity of enemies destroyed by the player in the game, a number of assists, a number of times to fend off damage for teammate players, and a blood amount replenished for teammate players, and the like. It should be understood that different game contents correspond to different game records, which are used here as an example only, and the embodiments of the present disclosure do not limit the game records in any way.

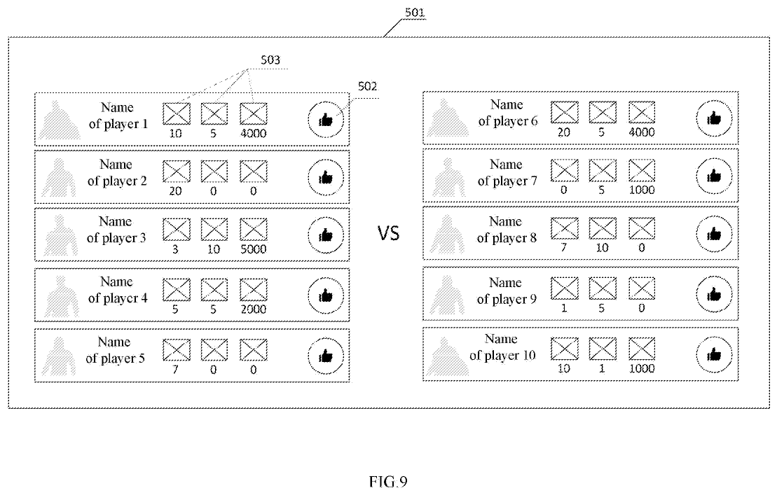

FIG. 9 is a schematic diagram of a global appreciation interface provided by an embodiment of the present disclosure. In this example, it is assumed that all players in the game are divided into two teams. As shown in FIG. 9, summary information of all players in the first team is displayed in a left display region of the global appreciation interface 501, and summary information of all players in the second team is displayed in a right display region of the global appreciation interface 501. The appreciation control 502 is arranged at the end of the summary information of each player, that is, each player corresponds to one appreciation control. The summary information of each player includes an avatar, a name and a game record 503 of the player. As an example, FIG. 9 shows three game records of each player. Taking player 1 as an example, the three game records of player 1 show that the player 1 destroyed 10 enemies, assisted 5 times, and replenished 4000 blood amount for teammates in total in this game.

In some embodiments, after step 230, the processing method also includes the following step 240.

In step 240: in response to an appreciation operation on a target game player in the global appreciation interface, second appreciation information is sent to a third terminal device corresponding to the target game player, the target game player includes at least one of the all game players. The second appreciation information is appreciation evaluation information determined according to the game interaction, which is similar to the first appreciation information of the above embodiments. For details, reference may be made to the step 120.

In some embodiments, the target game player may be players other than the first game player and other players other than the second game player selected by the first game player on the recommendation and appreciation interface.

In some embodiments, the second appreciation information is appreciation evaluation information determined according to a selected operation on the at least one preset appreciation evaluation information, and the second appreciation information includes an appreciation label. Specifically, in response to a click operation on the appreciation control on the global appreciation interface, an appreciation label selection window is displayed on an upper layer of the global appreciation interface. The appreciation label selection window includes a plurality of appreciation labels or user-defined appreciation label regions that may be selected by the first game player. Further, in response to the appreciation operation that acts on the appreciation label or the user-defined appreciation label region, the appreciation label selected by the first game player is displayed on the global appreciation interface.

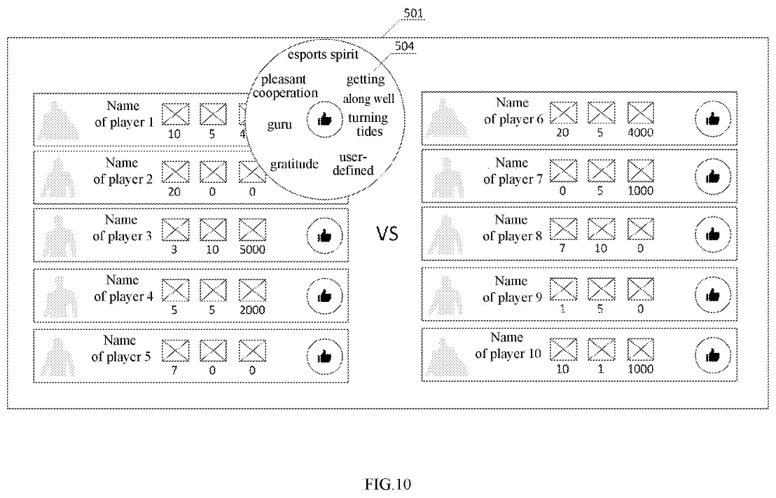

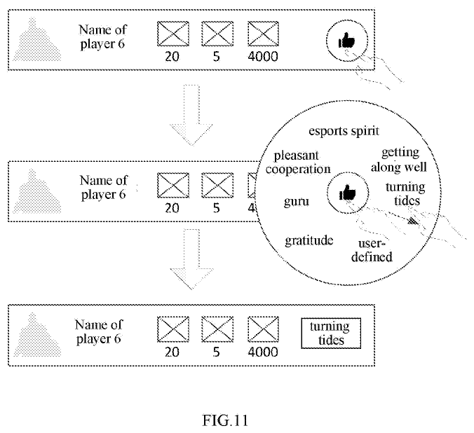

FIGS. 10 and 11 show interface changes of the players performing corresponding operations on the global appreciation interface.

FIG. 10 is a schematic diagram of a global appreciation interface provided by an embodiment of the present disclosure. As shown in FIG. 10, the first game player selects and clicks the appreciation control corresponding to a certain player (as shown in FIG. 10) on the global appreciation interface 501, and then controls an upper layer of a current interface to display the appreciation label selection window 504 in response to the operation of the first game player clicking the appreciation control, the appreciation label selection window 504 includes a plurality of appreciation labels or user-defined appreciation labels that may be selected by the first game player.

FIG. 11 shows a change of summary information of a player in a global appreciation interface provided by an embodiment of the present disclosure. As shown in FIG. 11, the first game player long presses the appreciation control corresponding to a certain player (player 6 in FIG. 10) on the global appreciation interface 501, and controls the upper layer of the current interface to display the appreciation label selection window in response to an operation of the first game player long pressing the appreciation control, the first game player keeps long pressing and moves to one of the appreciation labels in the appreciation label selection window, and then releases a finger or a mouse to successfully appreciate the other party with this appreciation label, and the appreciation label marked by the first game player is displayed at an end of the summary information of the player.

The first game player may supplement appreciation for other players in the game through the global appreciation interface shown in the above embodiments, which solves the problem that players cannot appreciate other players except the recommended players. Since the global appreciation interface displays the game record of each player in the game, it is convenient for players to know the game data of each player, which may improve the appreciation rate between the players.

FIG. 12 is a flow diagram of a method for processing recommendation information provided by an embodiment of the present disclosure. As shown in FIG. 12, the processing method provided by the present embodiment includes the following steps 310 to 330.

In the step 310: a recommendation and appreciation interface for at least one second game player is displayed on the graphical user interface, a game interaction between the at least one second game player and a first game player corresponding to the first terminal device meets a preset interaction condition.

In the step 320: in response to an appreciation operation on the second game player in the recommendation and appreciation interface, first appreciation information is sent to a second terminal device corresponding to the second game player.

The step 310 and step 320 of the present embodiments are the same as the step 110 to the step 120 of the above embodiments. For details, reference may be made to the foregoing embodiments, which is not repeated here.

In the step 330, the recommendation and appreciation interface is switched to a global appreciation interface for all game players after countdown ends. The global appreciation interface displays the summary information of each player in the game, and the global appreciation interface includes an appreciation control corresponding to each player.

The present embodiment is the switching of the graphical user interface based on a timer (a preset operation time for the player to perform the appreciation operation on the recommendation and appreciation interface). It should be noted that if the timer times out, the graphical user interface jumps regardless of whether the first gamer selects the at least one recommended second game player for appreciation.

If the first gamer has selected one or more second game players for appreciation on the recommendation and appreciation interface, the appreciation is submitted before the interface is switched. If the first game player fails to perform the selection on the recommendation and appreciation interface, the recommendation and appreciation interface is directly switched to the global appreciation interface. The first game player may select any player in the game on the global appreciation interface.

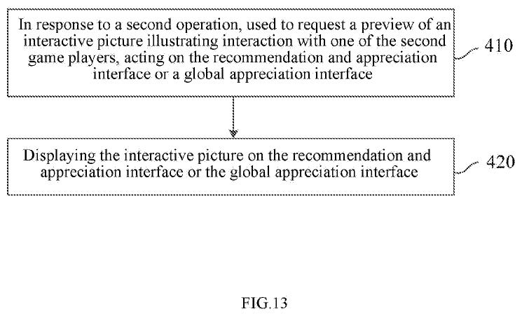

FIG. 13 is a flow diagram of a method for processing recommendation information provided by an embodiment of the present disclosure. As shown in FIG. 13, based on the above embodiments, the method for processing recommendation information may also include the following steps 410 and 420.

In the step 410: in response to a second operation acting on the recommendation and appreciation interface or a global appreciation interface, the second operation is used to request a preview of an interactive picture illustrating interaction with one of the second game players.

The second operation of the present embodiment may include any one of the following: a long press operation, a sliding operation, a double click operation, and the like, which is not limited in the present embodiment.

In an embodiment, the second operation acting on the recommendation and appreciation interface or the global appreciation interface includes the sliding operation of sliding a mouse pointer to an avatar of the second game player or an avatar of the target game player.

In the step 420: the interactive picture is displayed on the recommendation and appreciation interface or the global appreciation interface.

In the embodiment of the present disclosure, the first game player may view the name, the avatar, the interaction record and the appreciation label of any one of the recommended second game players on the recommendation and appreciation interface, and may also view the name, the avatar, the interaction record and the appreciation label of any one of the game players on the global appreciation interface. The first game player may request the preview of the interactive picture illustrating game interaction between the first game player and a clicked player by clicking the name, the avatar, the interaction record or the appreciation label of any game player on the recommendation and appreciation interface or the global appreciation interface.

Specifically, the interactive picture may be a picture when the first game player and the clicked player jointly destroy the enemy, or may be a picture that the clicked player gives life value to the first game player, or may be a picture that the first game player collaborates with the clicked player, or may be a picture that the clicked player helps the first game player to fend off damage. Of course, the interactive picture may also be a picture of other game interaction types, which is not limited in the present embodiment.

The interactive picture in the embodiment of the present disclosure may help the first game player to review some of the game interactive pictures in the game, so that the first game player may recall the contribution of the teammate players in the game according to the interactive picture, so as to select the player to be appreciated and improve the appreciation rate between the players.

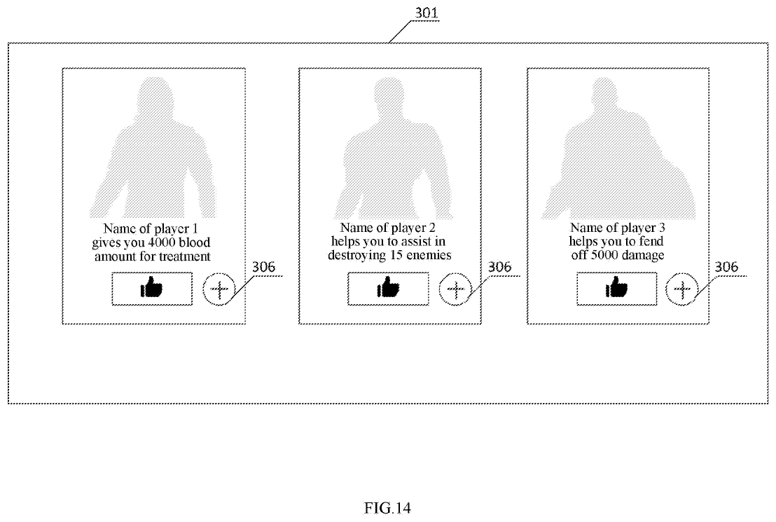

In some embodiments, in some embodiments, the recommendation and appreciation interface or the global appreciation interface may also include a friend-add control. FIG. 14 is a schematic diagram of a recommendation and appreciation interface provided by an embodiment of the present disclosure. As shown in FIG. 14, the recommendation and appreciation interface 301 recommends three players to the first game player, namely player 1, player 2, and player 3. A name of the player, an interaction record with the first game player, an appreciation control 302, and a friend-add control 306 are displayed below each player's avatar. The recommendation and appreciation interface provided by the present embodiment is convenient for the first game player to send friend request to other player while appreciating the other player, so as to improve the interaction between the players. A friend-add control on the global appreciation interface is similar to that on the recommendation and appreciation interface, which is not repeated here. The control form is shown in FIG. 14.

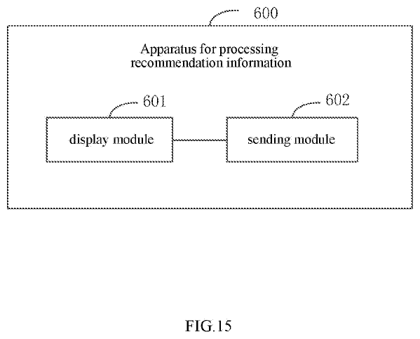

FIG. 15 is a structural diagram of an apparatus for processing recommendation information provided by an embodiment of the present disclosure. As shown in FIG. 15, the apparatus for processing recommendation information 600 of the present embodiment includes a display module 601 and a sending module 602.

The display module 601 is configured to display a recommendation and appreciation interface for at least one second game player on the graphical user interface, a game interaction between the at least one second game player and a first game player corresponding to the first terminal device meets a preset interaction condition;
the sending module 602 is configured to send first appreciation information to a second terminal device corresponding to the second game player in response to an appreciation operation on the second game player in the recommendation and appreciation interface.

In some embodiments, the first appreciation information is appreciation evaluation information determined according to the game interaction.

In some embodiments, the recommendation and appreciation interface includes an appreciation control corresponding to each second game player.

In one possible implementation, the sending module 602 is specifically used for:
in response to the appreciation operation acting on the appreciation control, sending the second terminal device corresponding to the second game player the first appreciation information.

In one possible implementation, the display module 601 is also used for:

in response to a first operation acting on the recommendation and appreciation interface, switching the recommendation and appreciation interface to a global appreciation interface for all game players, wherein the all game players includes the second game player.

In one possible implementation, the sending module 602 is also used for:

in response to an appreciation operation on a target game player in the global appreciation interface, sending second appreciation information to a third terminal device corresponding to the target game player, wherein the target game player includes at least one of the all game players.

In some embodiments, the global appreciation interface provides at least one preset appreciation evaluation information, and the second appreciation information is appreciation evaluation information determined according to a selected operation on the at least one preset appreciation evaluation information.

In some embodiments, the preset interaction condition includes at least one of the following conditions:
a number of game interactions being greater than a preset number threshold, and a game interaction duration being greater than a preset time threshold.

In some embodiments, the recommendation and appreciation interface further includes at least one of a name, an avatar, an interaction record and an appreciation label of the second game player.

In some embodiments, the first appreciation information is displayed on the appreciation control.

In some embodiments, the recommendation and appreciation interface further includes a first control, and the first control is used to skip an appreciation operation on the second game player or submit an appreciation for the second game player.

In some embodiments, the recommendation and appreciation interface further includes a second control used to display countdown information.

In one possible implementation, the display module 601 is also used for:
switching the recommendation and appreciation interface to a global appreciation interface for all game players after countdown ends.

In some embodiments, the preset interaction condition includes a preset interaction condition related to a game interaction type, and the game interaction type includes at least one of the following: an assist type, a rescue type, a collaboration type, and a guard type.

In some embodiments, the preset interaction condition of the assist type includes: a quantity of enemies destroyed together with the first game player being greater than a first quantity, or a number of assists for the first game player being greater than a first number;
the preset interaction condition of the rescue type includes: a total amount of a life value given to the first game player being greater than a second quantity, or a number of rescues for the first game player being greater than a second number;
the preset interaction condition of the collaboration type includes: a number of collaborations with the first game player being greater than a third number;
the preset interaction condition of the guard type includes: a total amount of damage off which the first game player is helped to fend being greater than a third quantity, or a number of times that the first game player is helped to fend off damage being greater than a fourth number.

In one possible implementation, the display module 601 is also used for:
in response to a second operation, used to request a preview of an interactive picture illustrating interaction with one of the second game players, acting on the recommendation and appreciation interface or a global appreciation interface,
displaying the interactive picture on the recommendation and appreciation interface or the global appreciation interface.

The apparatus for processing recommendation information provided by the present embodiment may be used to implement the technical solutions of the above method embodiments. An implementation principle and a technical effect thereof are similar to those of the method embodiments, and are not further described herein.

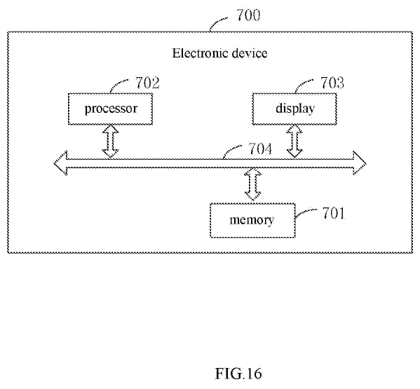

FIG. 16 is a schematic diagram of a hardware structure of an electronic device provided by an embodiment of the present disclosure. As shown in FIG. 16, the electronic device 700 provided by the present embodiment includes:
a memory 701, a processor 702, and a display 703.
the memory 701 is configured to store a computer program and data;
the processor 702 is configured to call the computer program stored in the memory 701 to cause the processor 702 to execute the method for processing the recommendation information according to any one of the above technical solution;
the display 703 is configured to render the data to the graphical user interface

In some embodiments, the memory 701 may be either independent or integrated with the processor 702.

When the memory 701 is a component independent of the processor 702, the electronic device 700 also includes a bus 704 for connecting the memory 701 and the processor 702.

The embodiments of the present disclosure also provide a computer-readable storage medium having a computer program stored thereon, and the computer program is executed by the processor 702 to execute the steps in the above method embodiments.

The embodiment of the present disclosure further provides a chip, which includes a processing module and a communication interface, the processing module being able to execute the steps in the above method embodiments.

Further, the chip further includes a memory module (e.g., memory), the memory module is configured to store an instruction, the processing module is configured to execute the instruction stored in the memory module, and an execution of the instruction stored in the memory module causes the processing module to execute the steps in the above method embodiments.

It should be understood that the above processor may be a central processing unit (CPU), and can also be general purpose processors, digital signal processors (DSPs), application specific integrated circuits (ASICs). The general purpose processor may be a microprocessor can also be any conventional processor, and so on.

The steps of the method disclosed in combination with the present invention can be directly embodied as executed by a hardware processor, or executed by a combination of hardware and software modules in the processor.

The memory may include a high-speed RAM memory, or may also include a non-volatile storage NVM, such as at least one magnetic disk memory, and may also be a U disk, a mobile hard disk, a read-only memory, a magnetic disk, or an optical disk.

The bus may be an Industry Standard Architecture (ISA) bus, a Peripheral Component (PCI) bus, or an Extended Industry Standard Architecture (EISA) bus. The bus may be divided into an address bus, a data bus, a control bus, and the like. For ease of representation, the bus in the drawings of the disclosure does not limit to only one bus or one type of bus.

The above storage medium may be implemented by any type of volatile or non-volatile storage device or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk. The storage medium may be any available medium that can be accessed by the general-purpose or special-purpose computer.

An exemplary storage medium is coupled to the processor so that the processor can read information from the storage medium and can write information to the storage medium. In addition, the storage medium may also be a component of the processor. The processor and the storage medium may be located in the application specific integrated circuits (ASICs). The processor and the storage medium may also exist as discrete components in the electronic device or the main control device.

Finally, it should be noted that the above embodiments are only used to illustrate the technical solutions of the present disclosure, not to limit them; although the present disclosure has been described in detail with reference to the foregoing embodiments, those of ordinary skill in the art should understand that they can still modify the technical solutions described in the foregoing embodiments, or equivalently replace some or all of the technical features; these modifications or replacements do not cause the essence of the corresponding technical solutions to deviate from the scope of the technical solutions of the embodiments of the present disclosure.

1. A method for processing recommendation information, comprising:
generating, by a first terminal device, a graphical user interface by executing and rendering a game application on a display of the first terminal device;
displaying a recommendation and appreciation interface for at least one second game player on the graphical user interface, wherein a game interaction between the at least one second game player and a first game player corresponding to the first terminal device meets a preset interaction condition;
in response to an appreciation operation on the second game player in the recommendation and appreciation interface, sending first appreciation information to a second terminal device corresponding to the second game player.

2. The method according to claim 1, wherein the first appreciation information is determined according to the game interaction.

3. The method according to claim 1, wherein the recommendation and appreciation interface comprises an appreciation control corresponding to the second game player; the in response to the appreciation operation on the second game player in the recommendation and appreciation interface, sending the first appreciation information to the second terminal device comprises:
in response to the appreciation operation acting on the appreciation control, sending the second terminal device the first appreciation information.

4. The method according to claim 1, further comprising:
in response to a first operation acting on the recommendation and appreciation interface, displaying a global appreciation interface for all game players, wherein the all game players comprises the second game player.

5. The method according to claim 4, further comprising:
in response to an appreciation operation on a target game player in the global appreciation interface, sending second appreciation information to a third terminal device corresponding to the target game player, wherein the target game player comprises at least one of the all game players.

6. The method according to claim 5, wherein the global appreciation interface provides at least one preset appreciation evaluation information, and the second appreciation information is determined according to a selected operation on the at least one preset appreciation evaluation information.

7. The method according to claim 1, wherein the preset interaction condition comprises at least one of the following conditions:
a number of game interactions being greater than a preset number threshold, and a game interaction duration being greater than a preset time threshold.

8. The method according to claim 1, wherein the recommendation and appreciation interface further comprises at least one of a name, an avatar, an interaction record and an appreciation label of the second game player.

9. The method according to claim 3, wherein the first appreciation information is displayed on the appreciation control.

10. The method according to claim 1, wherein the recommendation and appreciation interface further comprises a first control, and the first control is used to skip an appreciation operation on the second game player or submit an appreciation for the second game player.

11. The method according to claim 1, wherein the recommendation and appreciation interface further comprises a second control used to display countdown information.

12. The method according to claim 11, further comprising:
displaying a global appreciation interface for all game players after countdown ends.

13. The method according to claim 1, wherein the preset interaction condition is related to a game interaction type, and the game interaction type comprises at least one of the following: an assist type, a rescue type, a collaboration type, and a guard type.

14. The method according to claim 13, wherein the preset interaction condition of the assist type comprises: a quantity of enemies destroyed together with the first game player being greater than a first quantity, or a number of assists for the first game player being greater than a first number;
the preset interaction condition of the rescue type comprises: a total amount of a life value given to the first game player being greater than a second quantity, or a number of rescues for the first game player being greater than a second number;
the preset interaction condition of the collaboration type comprises: a number of collaborations with the first game player being greater than a third number;
the preset interaction condition of the guard type comprises: a total amount of damage off which the first game player is helped to fend being greater than a third quantity, or a number of times that the first game player is helped to fend off damage being greater than a fourth number.

15. The method according to claim 1, further comprising:
in response to a second operation, used to request a preview of an interactive picture illustrating interaction with one of the at least one second game player, acting on the recommendation and appreciation interface or a global appreciation interface, displaying the interactive picture on the recommendation and appreciation interface or the global appreciation interface.

16. (canceled)

17. An electronic device, comprising: a memory, a processor and a display;
wherein the memory is configured to store a computer program and data;
the processor is configured to call the computer program stored in the memory to cause the processor to execute a method for processing the recommendation information, the method comprises:
generating, by a first terminal device, a graphical user interface by executing and rendering a game application on a display of the first terminal device;
displaying a recommendation and appreciation interface for at least one second game player on the graphical user interface, wherein a game interaction between the at least one second game player and a first game player corresponding to the first terminal device meets a preset interaction condition;
in response to an appreciation operation on the second game player in the recommendation and appreciation interface, sending first appreciation information to a second terminal device corresponding to the second game player;
the display is configured to render the data to the graphical user interface.

18. (canceled)

19. The electronic device according to claim 17, wherein the first appreciation information is determined according to the game interaction.

20. The electronic device according to claim 17, wherein the recommendation and appreciation interface comprises an appreciation control corresponding to the second game player; the in response to the appreciation operation on the second game player in the recommendation and appreciation interface, sending the first appreciation information to the second terminal device comprises:
in response to the appreciation operation acting on the appreciation control, sending the second terminal device the first appreciation information.

21. The electronic device according to claim 17, wherein the processor further executes the following operations:
in response to a first operation acting on the recommendation and appreciation interface, displaying a global appreciation interface for all game players, wherein the all game players comprises the second game player.

22. A non-volatile computer-readable storage medium having a computer program stored thereon, which, when executed by a processor, causes the processor to execute the following operations:
generating, by a first terminal device, a graphical user interface by executing and rendering a game application on a display of the first terminal device;
displaying a recommendation and appreciation interface for at least one second game player on the graphical user interface, wherein a game interaction between the at least one second game player and a first game player corresponding to the first terminal device meets a preset interaction condition;
in response to an appreciation operation on the second game player in the recommendation and appreciation interface, sending first appreciation information to a second terminal device corresponding to the second game player.
